(19) United States
(12) Patent Application Publication
(10) Pub. No.: US 2002/0103687 A1
(43) Pub. Date: Aug. 1, 2002

(54) System and method for ordering contract workers

(76) Inventor: Debbie Kipling, (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/774,562

(22) Filed: Feb. 1, 2001

Related U.S. Application Data
(60) Provisional application No. 60/179,490, filed on Feb. 1, 2001.

(51) Int. Cl. G06F 17/60

(52) U.S. Cl. 705/8

(57) ABSTRACT

Systems and methods consistent with the present invention provide a network based service for ordering contract workers. The system receives an order from a client, including criteria identifying qualifications for a worker. The system then notifies a set of suppliers of the order and receives at least one submission from a supplier, including information identifying a suggested worker intended to satisfy the order. The system forwards information corresponding to the submission to the client for review. After receiving from the client an approval associated with the suggested worker, the system notifies the suggested worker of the approval.

This application claims the benefit of U.S. Provisional Patent Application No. 60/179,490, entitled, “Method and Apparatus for Ordering Contract Workers,” filed on Feb. 1, 2000, the disclosure of which is expressly incorporated by reference in its entirety into this application.

### BACKGROUND OF THE INVENTION

1. Field of the Invention

The present invention relates to methods and systems for managing people and, more particularly, to methods and systems for retaining or assigning contract workers over an electronic network.

2. Description of the Related Art

For a variety of reasons, companies often retain outside firms for permanent staff or temporary worker recruitment. Traditionally, such workers have been recruited or retained by a representative of the company (a client) contacting a so-called “brick and mortar” temporary placement agency. Upon contacting the agency, the client would then submit an order for a desired contract worker. The agency then processes the order, often by contacting one or more third parties who supply such contract workers. Sometime later, the agency provides the client with a list of candidates for completing the order.

This process for ordering contract workers with such agencies is, however, inefficient. First, the order process often takes a substantial amount of time since it typically involves geographically disbursed parties. Second, the typical order process fails to provide the client with adequate resources for obtaining up-to-date status on the order. For example, to obtain status on the order, the client often needs to make an appointment, either telephonic or in person, with the agency. But even when this can be done, the agency often does not have accurate information on the status of the order since it is in the hands of other parties (e.g., third party suppliers). The client may also want more frequent updates on the status of the order than the agency is able to provide.

Thus, it is desired to have a system for ordering contract workers through which parties can easily interact during the ordering process. Further, it is desired to have such a system that can provide parties with accurate status updates on the progress of an order.

### SUMMARY OF THE INVENTION

Systems and methods consistent with the present invention provide a network based service for the ordering of contract worker services. Systems and methods consistent with the invention also provide a simplified and uniform tool for ordering contract workers, processing those orders, and obtaining the status on those orders.

To achieve these and other advantages, a contract worker ordering system consistent with the present invention receives an order from a client, including criteria identifying qualifications for a worker. The system then notifies a set of suppliers of the order and receives at least one submission from a supplier, including information identifying a suggested worker intended to satisfy the order. The system forwards information corresponding to the submission to the client for review. After receiving from the client an approval associated with the suggested worker, the system notifies the suggested worker of the approval.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a block diagram of a contract worker ordering system (CWOS) 100 consistent with the present invention;

FIG. 2 is a block diagram of an application server (AS) 110 consistent with the present invention;

FIG. 3 is a flow diagram of a method for ordering contract workers using CWOS 100; and

FIGS. 4A to 4G are diagrams of graphical user interfaces of CWOS 100 displayed to a user.

### DETAILED DESCRIPTION

Overview

Systems and methods consistent with the present invention provide a network based service for ordering contract workers. The system receives from client terminals order requests specifying particular job positions and qualification criteria that candidates for the position must meet. The system distributes information from these orders to management terminals operated by resource managers of the system and to supplier terminals operated by parties who supply contract workers. The management terminal receives information on candidates for the position from the supplier terminal and forwards information on selected candidates to the client terminal. The system then allows the client to interview a candidate, approve a candidate for retention or assignment, or reject the candidate altogether.

The system tracks and manages the order request throughout the order process. To this end, the system provides all users (e.g., clients, resource managers, and suppliers) associated with an order with updated information on the status of the order. The system also automatically notifies users when an action requires their input or feedback.

System Implementation

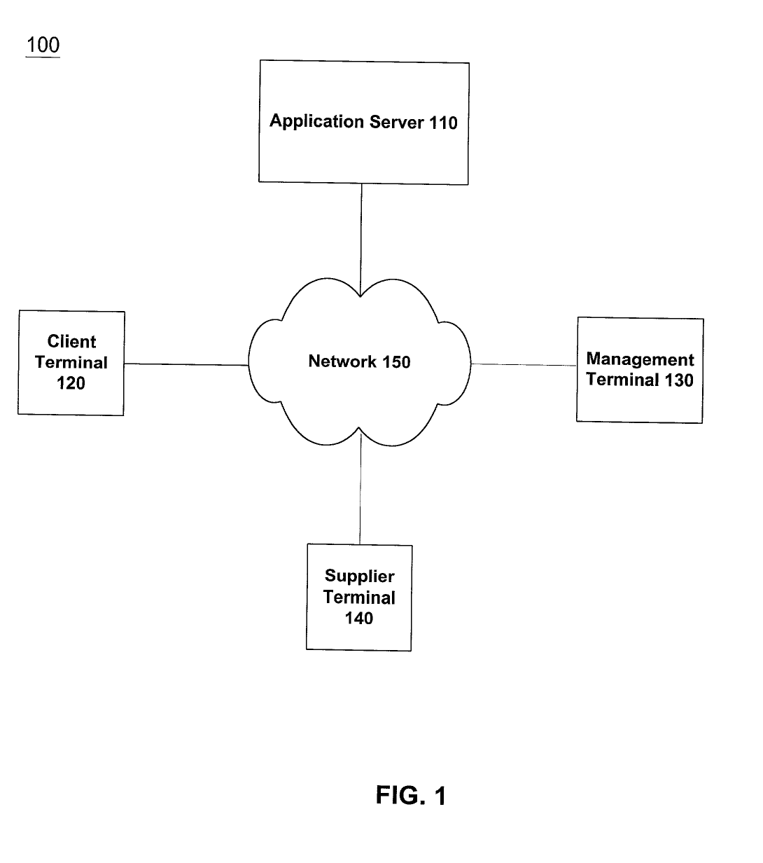

Embodiments of the present invention will now be described with reference to the accompanying drawings. FIG. 1 shows a block diagram of a contract worker ordering system (CWOS) 100 consistent with the present invention. As shown in FIG. 1, CWOS 100 includes an application server (AS) 110, a client terminal 120, a management terminal 130, a supplier terminal 140, and a network 150 for connecting AS 110 with terminals 120, 130, and 140. While network 150 is preferably the Internet, other types of networks (public or private, or local area network or wide area network) may be used to implement CWOS 100. Further, while FIG. 1 shows only one of terminals 120, 130, and 140, any number of terminals may be used as part of CWOS 100. CWOS 100 may also manage order requests for a wide range of client users or may be used to manage groups of client users having similar needs for placement of contract workers.

Client terminal 120, management terminal 130, and supplier terminal 140 may include a personal computer, such as an IBM-compatible computer, or the like, with a connection to network 150. Terminals 120, 130, and 140 preferably operate a browser software application (not shown), such as “Navigator” from Netscape Communications Corp. The operation of such browser applications and the manner in which they are used to access computers, such as servers, accessible via the Internet, an intranet, or some equivalent data network, are known in the art. Alternatively, each of the terminals may be specially equipped with communications software used to communicate via network 150 with AS 110.

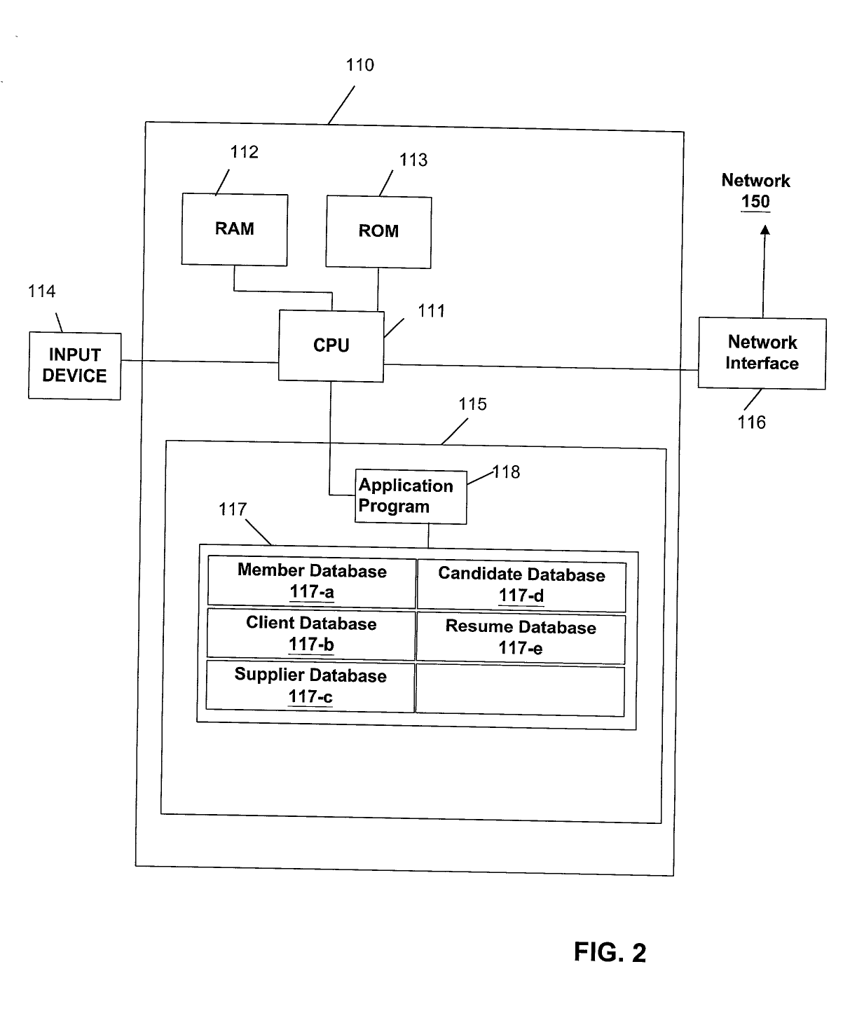

FIG. 2 is a block diagram of AS 110 consistent with the present invention. As shown in FIG. 2, AS 110 includes a central processing unit (CPU) 111, random access memory (RAM) 112, read-only memory (ROM) 113, at least one data input device 114, data storage device 115, and a network interface 116. Certain known devices may also be used to improve the security of AS 110, including firewalls and virtual private network technology.

As shown in FIG. 2, CPU 111 is directly coupled to each of the other elements of AS 110, although, in an alternative configuration, network interface 116 may be coupled to CPU 111 via a communication port (not shown). CPU 111 executes program code (not shown) stored in one or more of RAM 112, ROM 113, and data storage device 115 to carry out the functions and acts described in connection with AS 110. CPU 111 comprises at least one high-speed digital data processor adequate to execute program modules consistent with the invention, such as an application program for processing order requests for contract workers. CPU 111 interacts with RAM 112, ROM 113, and storage device 115 to execute stored program code according to conventional data processing techniques.

Data input device 114 permits AS 110 to receive information and, although shown as a single device, may comprise one or more data input devices of various types, such as an alphanumeric keyboard, a numeric keypad, a bar code scanner, a disk drive, a memory, an electronic communication line, and a wireless transceiver. Input device 114 transmits received information to CPU 111 for storage in data storage device 115. Data storage device 115 preferably comprises a large capacity memory capable of maintaining a program, such as application program 118, and at least one database 117.

Although AS 110 is depicted as a single device in FIG. 2, it may be made up of multiple devices, for example, a web server and a separate data processing system. In this configuration the web server would enable communications with AS 110 over the Internet and, in particular, the World Wide Web, and the data processing system would execute application program 118.

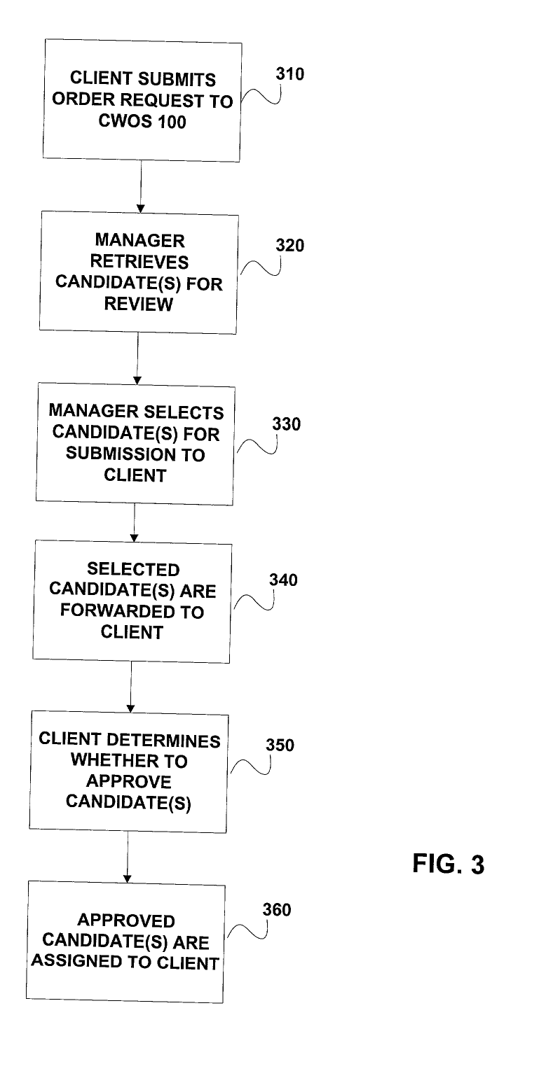

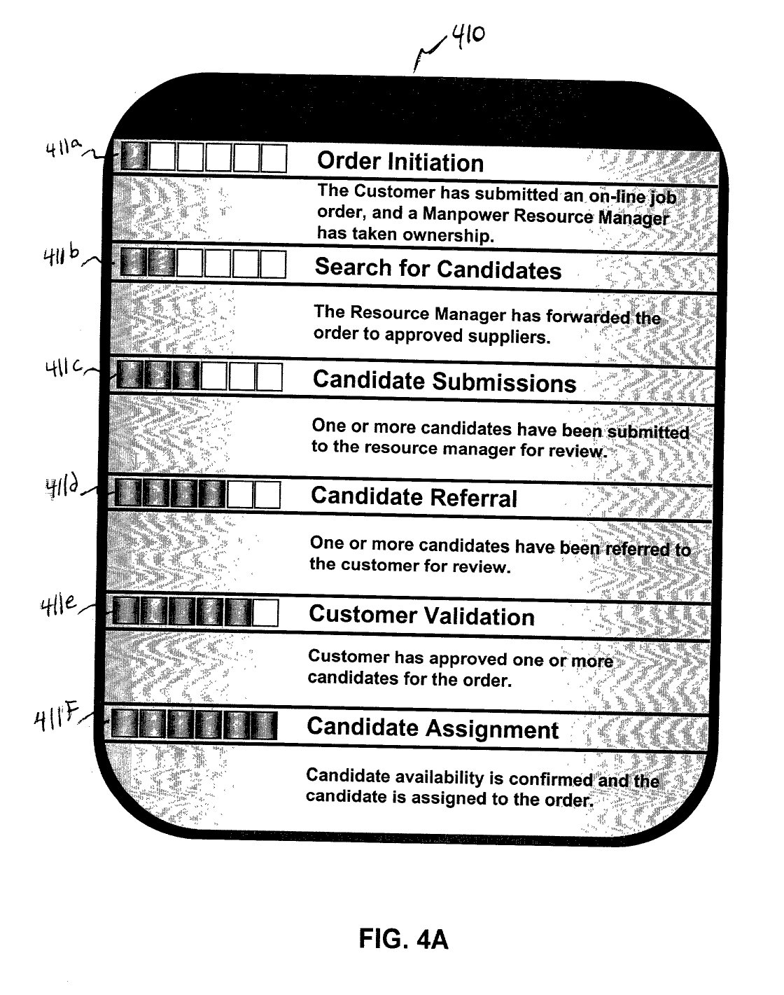

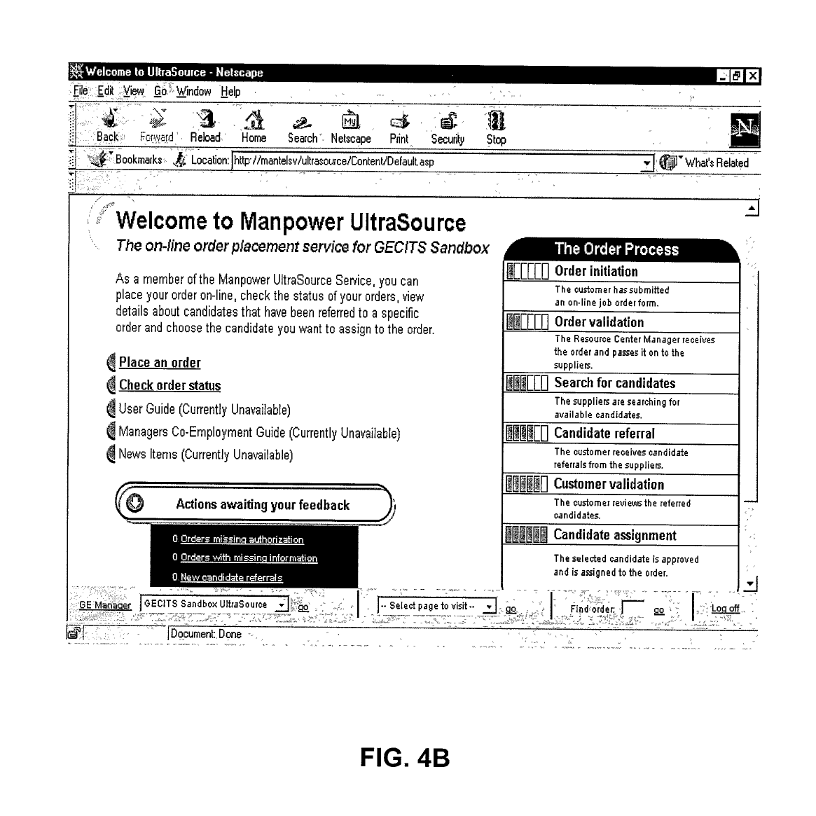

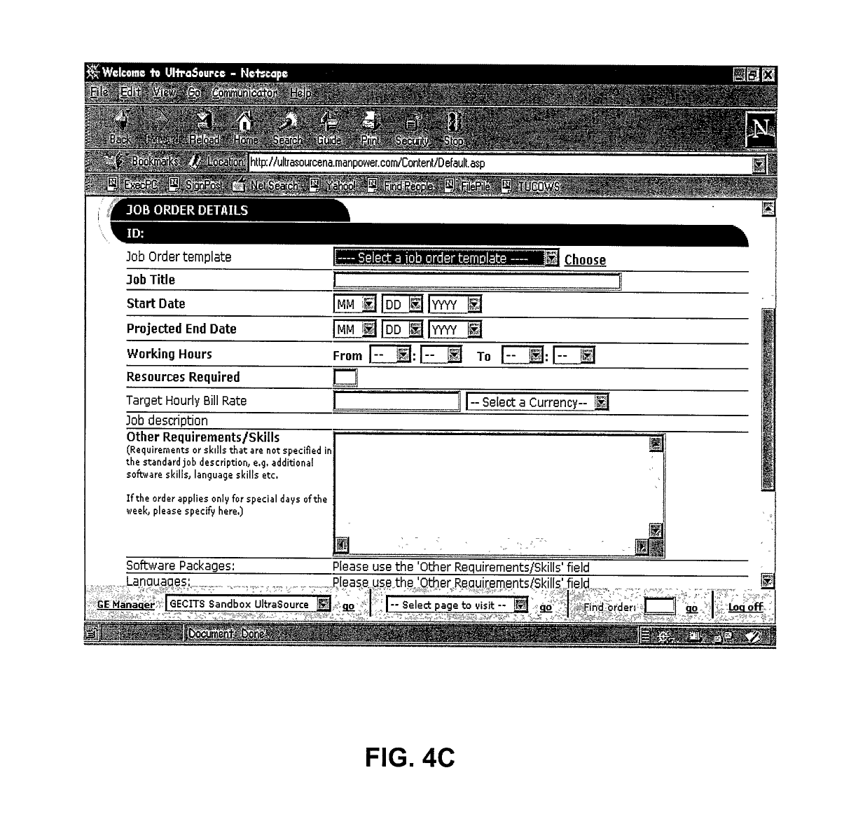

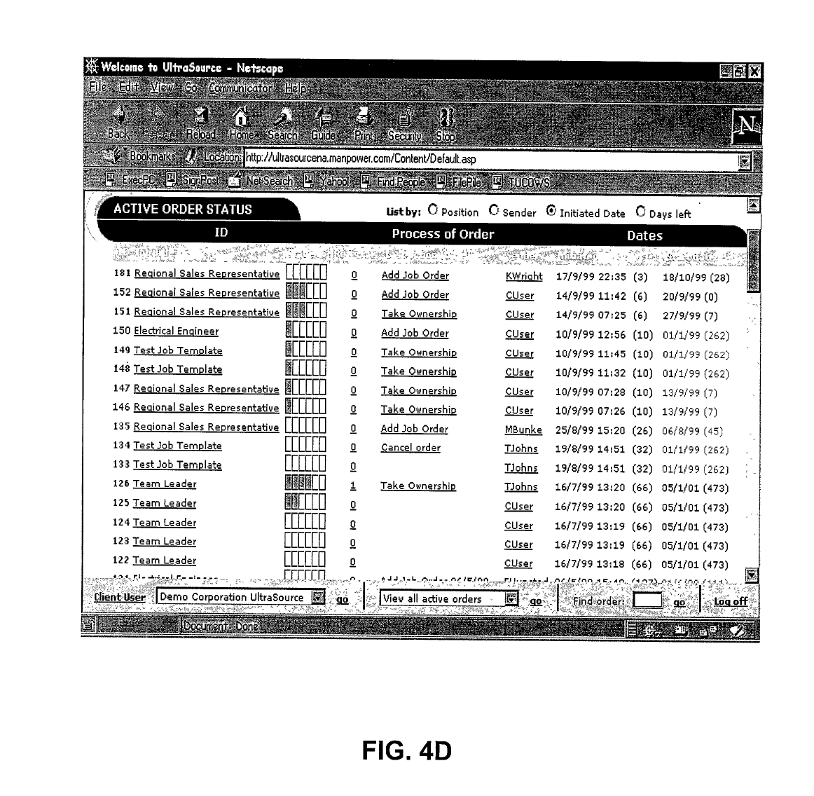

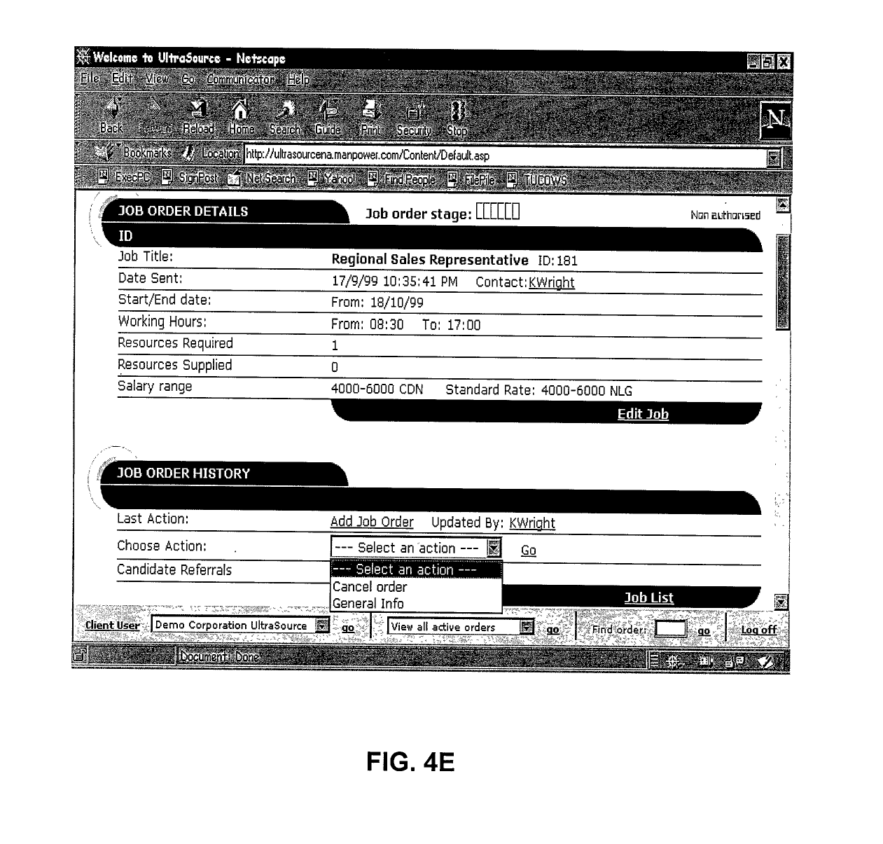

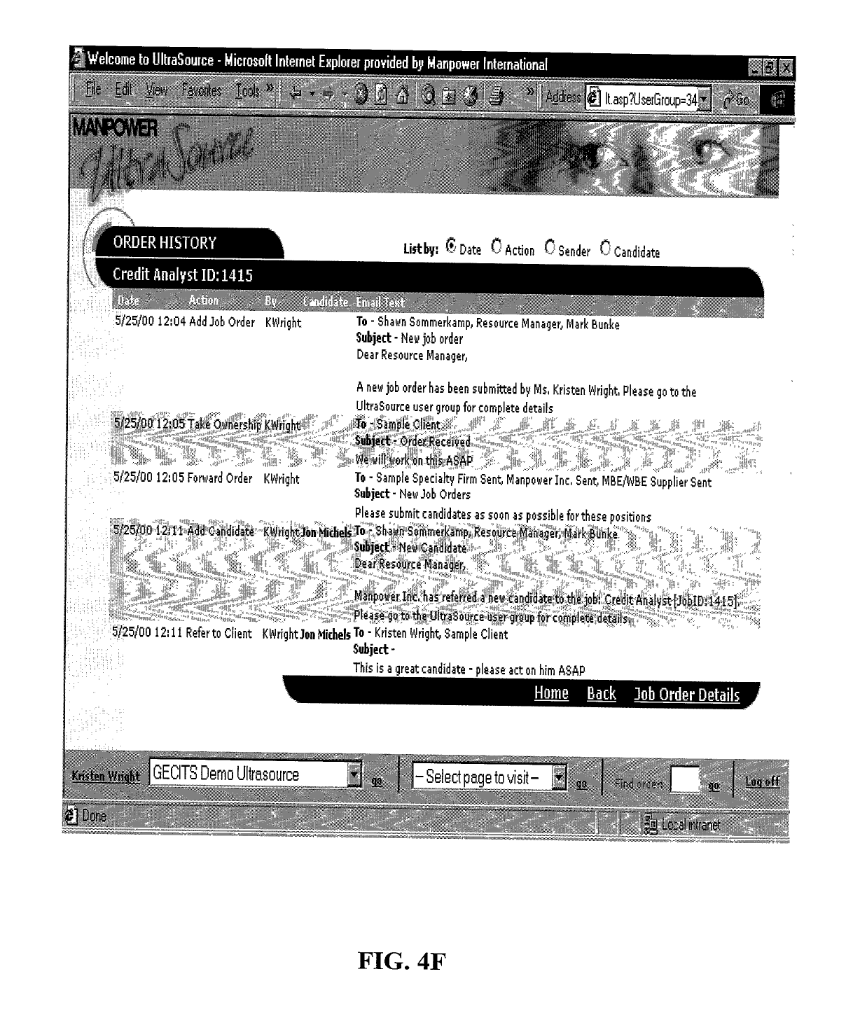

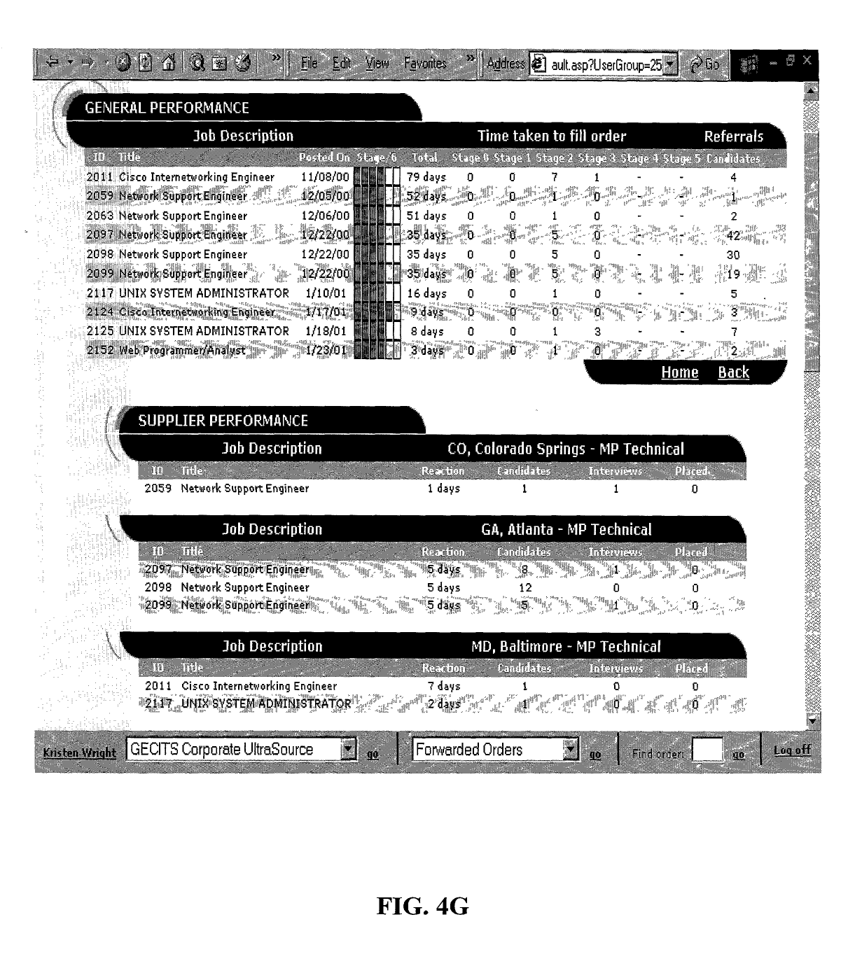

In one implementation consistent with the principles of the present invention, program 118 represents program instructions that provide functionality used to operate an application program for completing requests to order contract workers, for processing those requests, and for tracking the status of each request. Details on the functionality of application program 118 are described below with respect to FIGS. 3 and 4.

Database 117 further includes a set of databases 117-a to 117-e that application program 118 uses in operation, including: a member database 117-a that contains registration information about individuals from clients and suppliers permitted access to AS 110; a client database 117-b that contains information on clients' particular needs for contract workers; a supplier database 117-c that contains information on suppliers that provide candidates for contract work positions; a candidate database 117-d that contains information on candidates for various contract positions; and a resume database 117-e that contains information on resumes or other files associated with qualifications of candidates. Those skilled in the art will recognize that other types of databases, and configurations of those databases, are within the scope of the invention as claimed. For example, the relational database structure of database 117 may be replaced or augmented by an object oriented database architecture.

In systems consistent with the present invention, AS 110 manages job order requests received from client terminal 120. Each job order request describes a particular job position that a client would like to fill. The order request preferably includes the position's title, the position's pay rate, and any other qualification criteria that a candidate must meet. A user at client terminal 120 completes the order request and sends it to AS 110, which then notifies management terminal 130. After receiving the order request from AS 110, a user at management terminal 130 submits information on job candidates meeting the specified criteria to the client via AS 110. Supplier terminal 140 may initially provide information on these candidates to the user at management terminal 130 via AS 110. Upon receiving the candidates, the client can then determine, through AS 110, whether to interview the submitted candidate(s), approve the candidate(s) for assignment, or reject the candidate(s) altogether.

AS 110 preferably provides client terminal 120, management terminal 130, and supplier terminal 140 with a number of graphical user interfaces (GUIs) for completing an order request, processing that request, and tracking its status. RAM 112, ROM 113, or storage device 115 may store the GUIs, such as in data files in Hypertext Markup Language (HTML) format. The browser of terminals 120, 130, and 140 may then communicate with AS 110 using the Hypertext Transfer Protocol (HTTP) or a secured socket layer. In particular, the browser may retrieve from AS 110 data files (e.g., web pages), which may be in the HTML format and may include text, graphics, audio, and video. The web pages serve as the GUIs, and, as described above, may include web pages for completing an order request, processing the request, and tracking its status.

Further, AS 110 preferably includes a search engine (not shown) that performs searches, using an SQL or other well known technique, on the information stored in database 117. For example, terminals 120, 130, or 140 may direct AS 110 to commence execution of a specified search program contained in AS 110, such as by filling out search terms in “forms” from the browser of these terminals. This program may contain the search engine that searches, based on received search terms, information stored in database 117 for presentation to a user at terminal 120, 130, or 140. AS 110 may then notify the users of the results upon completion of the search process.

It will be appreciated from the description below that the present invention may be implemented in software which is stored as executable instructions on a computer readable medium on AS 110 and terminals 120, 130, and 140.

System Operation

The operation of CWOS 100 will now be described with reference to FIG. 3. FIG. 3 shows a flow diagram of a method for ordering contract workers using AS 110. Preferably, users are required to complete a password login procedure before accessing AS 110. CWOS 100 may also require client users to complete an authorization process to confirm that the client's employer has authorized the submission of an order request for a worker. To either of these ends, CWOS 100 may store password or authorization information in member database 117-a.

As shown in FIG. 3, a client using terminal 120 submits an order request to AS 110 (step 310). As described above, the order request preferably includes the positions title and job description, the position's pay rate, and any other qualification criteria defined by the client. The client preferably completes the order request using one of the GUIs provided by AS 110. Upon receipt of the request, AS 110 notifies management terminal 130 of the new order request by, for example, automatically generating and sending an electronic mail message (e-mail) to terminal 130. While AS 110 preferably generates an e-mail to notify users of actions awaiting their feedback, AS 110 may notify users using other forms of communication, such as by telephone calls, Internet communications, and other forms of mailings.

Management terminal 130 then retrieves information on candidates responsive to the received order request (step 320). To this end, management terminal 130 may either query AS 110 for a list of possible candidates or forward the order request to supplier terminal 140 via AS 110 to obtain candidates. To search for candidates, AS 110 preferably operates the search engine to search the information on candidates stored in database 117 (e.g., in candidate database 117-d or resume database 117-e).

If management terminal 130 forwards the order request to supplier terminal 140 via AS 110, then AS 110 will notify supplier terminal 140 of the order request by, for example, automatically generating and sending an e-mail to terminal 140. Supplier terminal 140 (or the supplier at terminal 140) will then search its databases or records (not shown) for possible candidates meeting the positions qualifications. Information on these candidates are then forward to management terminal 130, preferably accompanied by an e-mail notification via AS 110. Finally, while FIG. 1 shows only one supplier terminal 140, management terminal 130 may select from any number of suppliers to contact. In this case, management terminal 130 may search supplier profile information stored in supplier database 117-c of AS 110 to generate a list of those suppliers that supply contract workers responsive to the particular order request. The order request is then forwarded to only those identified suppliers.

Based on the retrieved candidate information, management terminal 130 then selects those candidates for submission to client terminal 120 via AS 110 (step 330). For example, a resource manager at terminal 130 may screen the candidates received from supplier terminal 140 to ensure that only qualified candidates are actually submitted to the client at client terminal 120. AS 110 notifies client terminal 120 of the submitted candidate information by, for example, automatically generating and sending an e-mail to terminal 120. Upon receipt of the submitted candidate information at client terminal 120 (step 340), the client decides whether to approve the submitted candidates for assignment (step 350).

In particular, the client may decide to either interview the candidate, approve the candidate for assignment, or reject the candidate. Client terminal 120 preferably notifies AS 110 of this decision using one of the GUIs of AS 110. Upon receipt of this notification, AS 110 then sends the appropriate notification to management terminal 130 by preferably automatically generating and sending an e-mail to terminal 130. If the client decides to interview a candidate, for instance, then either client terminal 120 or management terminal 130 will schedule the candidate for an interview with the client. If the client decides to reject the candidate, then AS 110 will notify management terminal 130 or supplier terminal 140, as necessary, of this decision.

If the client decides to approve the candidate for assignment, however, then client terminal 120 sends a notification to management terminal 130 via AS 110. The resource manager of management terminal 130 (or, alternatively, the client at client terminal 120) then contacts supplier terminal 140, via AS 110, to determine whether the candidate is still available. If so, the candidate is assigned to the client (step 360).

In systems consistent with the invention, CWOS 100 preferably stores and manages other information pertaining to the retention or assignment of contract workers as well. For instance, AS 110 may store information concerning amounts a client must pay for a particular contract worker. AS 110 may also keep track of this information throughout the term of employment of the contract worker.

### USER INTERFACES

As described above, systems consistent with the present invention provide graphical user interfaces (GUIs) for clients at client terminal 120, for resource managers at management terminal 130, and for suppliers at supplier terminal 140. In particular, AS 110 integrates each of the services and tools of CWOS 100 into a single user application program (e.g., application program 118) having various GUIs for completing an order request, processing that request, and tracking its status. FIGS. 4A to 4G are GUI screens of a user application program consistent with the present invention.

FIGS. 4A and 4B are exemplary GUI screens for illustrating how CWOS 100 may indicate the status of a particular order request. As shown in FIGS. 4A and 4B, the GUI includes a section 410 providing an overview of the order process. The order process may be separated into stages, for instance stages that generally correspond to steps 310 to 360 described above with respect to FIG. 3. The order process section 410 further includes status components 411a to 411d, each corresponding to a stage of the order process and including a series of bars equal to the total number of stages. As shown in FIG. 4, each component 411a to 411d has a certain number of bars highlighted. The number of highlighted bars indicates the particular stage associated with each respective component 411. For example, status component 411a has one highlighted bar to indicate the status of an order is that the order is in the first stage of the order process. More specifically, if the order request is at the first of six stages (i.e., client terminal 120 has forwarded the request to AS 110 and no other processing has taken place), then AS 110 associates the order request with component 411a, which has only the first of the six bars highlighted. In this way, CWOS 100 may indicate the status of a particular order request to users by associating one of status components 411 with the particular request. Finally, while order process section 410 describes an order process having six stages, section 410 and status components 411 may indicate the status of an order process having any number of stages.

The GUI of FIG. 4B also contains an “actions awaiting feedback” (AAF) section providing status information on order requests associated with a particular user, such as a client, resource manager, or supplier. Each AAF section preferably contains hyperlinks directing the user to additional information and GUI screens for each item requiring the user's attention. CWOS 100 preferably updates the AAF section for each user during processing of each order request.

For example, CWOS 100 may first update the AAF section for a resource manager when the management terminal 130 of that resource manager first receives an order request from client terminal 120. The AAF section therefore informs the manager that the order request is awaiting the manager's decision on whether to forward the request to a supplier or to take other action. If the order is forwarded to a supplier, CWOS 100 updates the supplier's AAF section to inform the supplier that it must supply information on candidates on this order. When supplier terminal 140 provides management terminal 130 with particular candidate information responsive to the order request, the resource manager's AAF section is again updated to reflect that the order request is awaiting the manager's approval of those candidates. After candidates are submitted to client terminal 120, the client's AAF section is updated to reflect that the client must decide on whether to approve the candidates. Other action items may also be included in a user's AAF section.

FIG. 4C illustrates an exemplary GUI for completing a job order request. As shown in FIG. 4C, a client may enter various criteria to define the qualifications that a candidate must meet for the particular contract position. This GUI preferably includes a pull-down menu to select one of a number of job order templates. Each template corresponds to a particular type of job position and contains predefined qualification criteria established by the client for that position. These templates therefore ease the task of entering orders so that a client can request a commonly needed contract worker with minimal effort. Further, the GUI of FIG. 4C is preferably customized to meet a particular client's needs in ordering contract workers. Finally, upon receipt of the order request, AS 110 stores the order request in client database 117-b, which also stores all information pertaining to qualification criteria for particular positions and information on any worker assigned to such positions.

FIG. 4D illustrates an exemplary GUI for providing a user a listing of all active orders and the status on those orders. As shown in FIG. 4D, each order is associated with one of status components 411 as described above with respect to FIGS. 4A and 4B. Each status component 411 indicates the current stage of each order in the order process. By selecting an order (e.g., by clicking with a mouse using hyperlink technology known in the art), the user is preferably presented with the GUI of FIG. 4E, which illustrates further information on the order request and its status in the order process.

CWOS 100 preferably provides GUI screens that users may use to manage the order requests associated with them. For instance, FIG. 4F illustrates an exemplary GUI for providing a user with the order history of a particular order request. As shown in FIG. 4F, the order history preferably includes, for each stage of the order process, the date each action was taken, the persons responsible for that action, and the e-mail text sent by AS 110. For example, the GUI shows that the order request of FIG. 4F was first submitted on May 25, 2000 at 12:04 p.m. The GUI further shows the e-mail sent by AS 110 to a resource manager at management terminal 130 notifying the resource manager of the order request. The resource manager could view the details of the order request by accessing AS 110 and retrieving an HTML image of the order stored in database 117-b.

Further, FIG. 4G illustrates an exemplary GUI for providing a summary report of one or more order requests. As shown in FIG. 4G, the GUI displays for each order request: information identifying the order, the date the order request was posted or submitted by the client, the current stage of the request (e.g., by displaying status component 411), the number of days elapsed since the date of posting, the time taken to complete each stage, and the number of candidates referred to the client. By providing this information, CWOS 100 provides users with an indication of how long orders have taken to complete. For example, users can obtain this information for order requests associated with certain types of job positions, resource managers, or suppliers. For instance, FIG. 4G shows that AS 110 may provide a GUI sorting information according to suppliers. For each supplier, the GUI lists the order requests associated with that supplier, the time taken for the supplier to respond to the order, the number of candidates the supplier provided, and how many of those candidates were interviewed and/or assigned by the client. Thus, the GUI of FIG. 4G allows a user to determine the performance or efficiency with respect to such order requests.

Through these GUIs of CWOS 100, users can, as described above, select candidates for assessment, review candidate profiles, approve candidates for assignment, confirm availability of candidates, or perform other type of management activity associated with the order request. Further, the GUIs allow clients, resource managers, and suppliers to process order requests using common templates, ensuring reliability and efficiency. The above GUIs are, however, exemplary and systems consistent with the present invention may use other GUIs as part of the order process.

Conclusion

Therefore, systems consistent with the present invention provide a single network based application for the procurement, tracking, and management of contract worker services. Moreover, systems and methods consistent with the invention provide a simplified and uniform tool for ordering contract workers. It will be apparent to those skilled in the art that various modifications and variations can be made to the system and method of the present invention without departing from the spirit or scope of the invention. For example, CWOS 100 may not include management terminal 130, with the functions performed by that terminal being performed by supplier terminal 140 or being automatically performed by AS 110. CWOS 100 may also not include supplier terminal 140, with the functions performed by that terminal being performed by management terminal 130. CWOS 100 may also be used for managing and ordering any type of worker or employee, such as for hiring permanent employees.

Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet; or other forms of RAM or ROM. The present invention covers the modifications and variations of this invention provided they come within the scope of the appended claims and their equivalents.

What is claimed is:

1. A computer-implemented method for ordering workers for a client, comprising:
receiving an order request including criteria identifying qualifications for a worker;
notifying a supplier of the order request;
receiving at least one candidate submission from the notified supplier, including information identifying a suggested worker intended to satisfy the order request;
forwarding information corresponding to the candidate submission to the client for review;
receiving from the client a candidate approval associated with the suggested worker; and
notifying the supplier of the candidate approval.

2. The method of claim 1, wherein receiving an order request further comprises:
generating a display screen including a selectable template identifying predetermined qualification criteria of a worker;
prompting the client to complete the order request using the selectable template; and
including in the order request the predetermined qualification criteria included in the selectable template.

3. The method of claim 1, wherein notifying a supplier further comprises:
selecting from a database, based on the qualification criteria included in the received order request, a particular supplier; and
notifying the particular supplier of the order request.

4. The method of claim 1, wherein forwarding information on a candidate to the client further comprises:
notifying the client of the suggested worker by automatically generating and sending an electronic mail message to the client.

5. The method of claim 1, wherein the order request is processed in a number of stages, the method further comprising:
determining the current stage of the order request;
generating a first display screen including status display components associated with each stage of the order request; and
modifying each status display component to reflect the current stage of the order request.

6. The method of claim 5, wherein the status display components correspond to a series of bars equal to the number of stages, the method further comprising:
highlighting the number of bars corresponding to the current stage.

7. The method of claim 5, further comprising:
generating a second display screen including a listing of order requests associated with a particular user; and
associating with each order request listed in the second display screen the corresponding status display component.

8. The method of claim 1, wherein the order request is processed in a number of stages, the method further comprising:
generating a display screen providing a summary of action taken on the order request during each processing stage, wherein the display screen displays, for each processing stage, text of an electronic mail sent to a user associated with the order request.

9. A computer-implemented method of ordering workers using a network, comprising:
providing an interface in the network for clients to obtain workers from a supplier of workers;
permitting clients to have access to the interface to specify order requests identifying an order for workers, the order request including criteria identifying qualifications for a worker;
permitting the supplier to have access to the order request based on the qualification criteria; and
receiving at least one candidate submission from the supplier, including information identifying a suggested worker intended to satisfy the order request.

10. A computer-implemented method for ordering workers, comprising:
determining, from a set of suppliers, a select group of suppliers capable of satisfying an order request based on stored information associated with the set of suppliers, the stored information including at least an identification of types of workers associated with each supplier;
notifying each supplier in the select group of suppliers about the order request;
receiving at least one candidate submission from the notified select group of suppliers, including information identifying a suggested worker intended to satisfy the order request; and
notifying a client associated with the order request of the candidate submission.

11. A computer for ordering workers, the computer comprising:
a memory having program instructions; and
a processor, responsive to the programming instructions, configured to:
receive an order request including criteria identifying qualifications for a worker;
determine from a set of suppliers a select group of suppliers capable of satisfying an order request based on stored information associated with the set of suppliers, the stored information including at least an identification of types of workers associated with each supplier;
notify each supplier terminal associated with the select group of suppliers about the order request;
receive at least one candidate submission from the notified select group of suppliers, including information identifying a suggested worker intended to satisfy the order request; and
notify the client terminal of the candidate submission.

12. A computer-implemented method for ordering workers for a client, comprising:
receiving from the client an order request including criteria identifying qualifications for a worker;
selecting candidate information from a database based on the identified qualification criteria in the order request, wherein the selected candidate information includes information identifying a suggested worker intended to satisfy the order request;
forwarding the candidate information to the client for review;
receiving from the client a candidate approval associated with the suggested worker; and
notifying the suggested worker of the approval.

13. The method of claim 12, wherein receiving an order request further comprises:
generating a display screen including a selectable template identifying predetermined qualification criteria of a worker;
prompting the client to complete the order request using the selectable template; and
including in the order request the predetermined qualification criteria included in the selectable template.

14. The method of claim 12, wherein forwarding the candidate information to the client further comprises:
notifying the client of the suggested worker by automatically generating and sending an electronic mail message to the client.

15. The method of claim 12, wherein the order request is processed in a number of stages, the method further comprising:
determining the current stage of the order request;
generating a display screen including display components associated with each stage of the order request; and
modifying each display component to reflect the current stage of the order request.

16. The method of claim 15, wherein the display components correspond to a series of bars equal to the number of stages, the method further comprising:
highlighting the number of bars corresponding to the current stage.

17. A computer for ordering workers, the computer comprising:
a memory having program instructions; and
a processor, responsive to the programming instructions, configured to:
receive from the client an order request including criteria identifying qualifications for a worker;
select candidate information from a database based on the identified qualification criteria in the order request, wherein the selected candidate information includes information identifying a suggested worker intended to satisfy the order request;
forward the candidate information to the client for review;
receive from the client a candidate approval associated with the suggested worker; and
notify the suggested worker of the approval.

18. A user interface, generated by a computer, for displaying status information of an order request, wherein the order request is processed in a number of stages, the interface comprising:
a status display component corresponding to a series of bars equal to the number of stages; and
wherein the user interface associates the status display component with the order request and highlights a subset of the series of bars of the status display component, wherein the number of highlighted bars corresponds to the current stage of the order request.

19. The user interface of claim 18, further comprising:
a summary report display component displaying order identification information, the status display component, and information identifying an amount of time elapsed for each stage of the order request.

20. A computer-implemented method for ordering workers for a client, comprising:
receiving an order request including criteria identifying qualifications for a worker, wherein the order request is processed in a number of stages and wherein receiving an order request further comprises: generating a display screen including a selectable template identifying predetermined qualification criteria of a worker, prompting the client to complete the order request using the selectable template, and including in the order request the predetermined qualification criteria included in the selectable template;
selecting from a database, based on the qualification criteria included in the received order request, a supplier;
notifying the supplier of the order request;
receiving at least one candidate submission from the notified supplier, including information identifying a suggested worker intended to satisfy the order request;
forwarding information corresponding to the candidate submission to the client for review, wherein forwarding information on a candidate to the client further comprises notifying the client of the suggested worker by automatically generating and sending an electronic mail message to the client;
receiving from the client a candidate approval associated with the suggested worker;
notifying the supplier of the candidate approval;
determining the current stage of the order request;
generating a first display screen including status display components associated with each stage of the order request, wherein the status display components correspond to a series of bars equal to the number of stages;
highlighting the number of bars corresponding to the current stage;
generating a second display screen including a listing of order requests associated with a particular user;
associating with each order request listed in the second display screen the corresponding status display component; and
generating a third display screen providing a summary of action taken on the order request during each processing stage, wherein the third display screen displays, for each processing stage, text of an electronic mail sent to a user associated with the order request.
